(19) United States
(12) Patent Application Publication
(10) Pub. No.: US 2014/0317567 A1
(43) Pub. Date: Oct. 23, 2014

(54) SYSTEMS AND METHODS FOR GRAPHICALLY DEPICTING PEOPLE AND INTERESTS

(71) Applicant: Andy Miller, Draper, UT (US)

(72) Inventor: Andy Miller, Draper, UT (US)

(21) Appl. No.: 14/200,783

(22) Filed: Mar. 7, 2014

Related U.S. Application Data
(60) Provisional application No. 61/774,300, filed on Mar. 7, 2013.

(51) Int. Cl. G06F 3/0481

(52) U.S. Cl. CPC G06F 3/04817
USPC 715/811

(57) ABSTRACT

A system of graphically depicting people and interests can comprise an anchor structure having a dimensional area, an identity icon adapted to be positioned on or adjacent to the anchor structure, and a plurality of interest icons adapted to be positioned on or adjacent to the anchor structure and having a graphical relationship to the identity icon. The identity icon can be prepared so that it has an area no larger than 25% of the dimensional area of the anchor structure. Likewise, the any one of the interest icons can also have an area no larger than 25% of the dimensional area of the anchor structure.

The present application claims the benefit of U.S. Provisional Patent Application No. 61/774,300, filed Mar. 7, 2013, the entirety of which is incorporated herein by reference.

### BACKGROUND

Stickers, magnets, and other media display systems have been used for many purposes, including for personal enjoyment, providing information to others, or for business purposes. Most typically, such media display systems are unitary and inseparable, e.g., a single sticker or magnet that includes all of the information that a user wishes to display. However, there are also decal systems and other similar systems that coordinate multiple images together to provide a unifying concept. A notable example includes individual letters positioned in a line or other arrangement to spell a word, though there are certainly other similar examples. That being stated, it is believed that it may be desirable to provide alternative media display systems and/or computer display systems for ordering such arrangements that are not currently known in the applicable arts.

### SUMMARY

The present disclosure is drawn to a modular system of graphically depicting people and interests. The system can be a media display system that includes an anchor structure having a dimensional area, an identity icon adapted to be positioned on or adjacent to the anchor structure, and a plurality of interest icons adapted to be positioned on or adjacent to the anchor structure and having a graphical relationship to the identity icon. In one example, the identity icon can have an area no larger than 25% of the dimensional area of the anchor structure. In another example, the interest icons can also have an area no larger than 25% of the dimensional area of the anchor structure. In one specific example, the identity icon can have an area no larger than 10% of the dimensional area of the anchor structure. In another specific example, the interest icons (individually) can have an area no larger than 10% of the dimensional area of the anchor structure.

In another embodiment, a method of graphically depicting people and interests can include obtaining an anchor structure, an identity icon, and a plurality of interest icons. Additional steps can include affixing the anchor structure to a substrate, affixing the identity icon to the anchor structure or adjacent to the anchor structure, and affixing the plurality of interest icons on the anchor structure or adjacent to the anchor structure at a location having a graphical relationship to the identity icon.

In another example, a method of digitally representing personal relationship or interest information can comprise electronically displaying an anchor structure icon, identity icon, and interest icons. The method can further comprise allowing a user to select and manipulate positioning of the anchor structure icon, one or more of the identity icons, and one or more of the interest icons on a computer display to generate an organized arrangement of the anchor structure icon, identity icon, and interest icons. This can provide a graphical representation of a personal relationship and/or interest information. Any or all of these steps can be carried out over a computer network.

### BRIEF DESCRIPTION OF THE DRAWINGS

FIG. 1 shows an example of a modular system for graphically organizing or representing people and interests in accordance with embodiments of the present disclosure;

FIG. 2 shows multiple examples of interest icons prepared in accordance with embodiments of the present disclosure;

FIGS. 3-6 depict alternative examples of the modular system for graphically organizing or representing people and interests in accordance with embodiments of the present disclosure; and

FIGS. 7-8 are block diagrams illustrating networked computer systems usable for organizing anchor structures, identity icons, and interest icons in accordance with embodiments of the present disclosure.

### DETAILED DESCRIPTION

Before the present disclosure is described herein, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

The following terminology will be used in accordance with the definitions set forth below.

As used herein, the singular forms “a,” and, “the” include plural referents unless the context clearly dictates otherwise.

As used herein, the term “substantially” refers to the complete or nearly complete extent or degree of an action, characteristic, property, state, structure, item, or result. The exact allowable degree of deviation from absolute completeness may in some cases depend on the specific context. However, generally speaking, the nearness of completion will be so as to have the same overall result as if absolute and total completion were obtained.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

In some examples, specific sizes, shapes, dimensions, etc. may be provided for illustrative purposes. However, such examples are intended to be non-limiting and a variety of other sizes, shapes, dimensions, etc. may be implemented to accommodate specific applications. These specific dimensions are not to be construed as critical to the present disclosure, and in fact, may be modified liberally for other specific configurations.

Reference will now be made to the exemplary embodiments illustrated, and specific language will be used herein to describe the same. It will nevertheless be understood that no limitation of the scope of the technology is thereby intended. Additional features and advantages of the technology will be apparent from the detailed description which follows, taken in conjunction with the accompanying drawings, together illustrating, by way of example, features of the technology.

As previously described, the present disclosure is drawn to a modular system of graphically depicting people (including relationships) and various interests. The system can include an anchor structure having a dimensional area, an identity icon adapted to be positioned on or adjacent to the anchor structure, and a plurality of interest icons adapted to be positioned on or adjacent to the anchor structure and having a graphical relationship to the identity icon. By the term “graphical relationship,” what is meant is that the interest icon is placed in proximity to the identity icon in a manner that there can be no confusion as to which identity icon or group of icons are to be associated with one another. An example includes icons that are touching, nearly touching, at least twice as close to one another compared to other possible icon pairings, or the like. This will be shown by example in the FIGS. that are to follow. In further detail regarding the various icons and spatial relationships between icons and the anchor structure, an individual identity icon may have an area no larger than 25% of the dimensional area of the anchor structure. In another example, a single interest icon may also have an area no larger than 25% of the dimensional area of the anchor structure. In one specific example, the identity icon may have an area no larger than 10% of the dimensional area of the anchor structure. In another specific example, a single interest icon may have an area no larger than 10% of the dimensional area of the anchor structure.

In another embodiment, a method of graphically depicting people and interests can include obtaining an anchor structure, an identity icon, and a plurality of interest icons. Additional steps can include affixing the anchor structure to a substrate, affixing the identity icon to the anchor structure or adjacent to the anchor structure, and affixing the plurality of interest icons on the anchor structure or adjacent to the anchor structure at a location having a graphical relationship to the identity icon. Again, the graphical relationship can be such that the interest icon is placed in proximity to the identity icon in a manner that there can be no confusion as to which identity icon or group of icons are to be associated with one another, as previously defined.

In another example, a method of graphically depicting personal relationship or interest information can comprise electronically displaying an anchor structure icon, an identity icon, and interest icons. The method can further comprise allowing a user to select and manipulate positioning of the anchor structure icon, the identity icon(s), and the interest icons on a computer display to generate an organized arrangement of the anchor structure icon, identity icon, and interest icons, thereby providing a graphical representation of a personal relationship or interest information. The method can further include the step of providing an option for ordering physical media product represented digitally by the organized arrangement. Any or all of these steps can be carried out over a computer network. In this specific example, there can be a single anchor structure icon to select, or multiple anchor structure icons to select. Furthermore, the identity icons or the interest icons can be positionable either on (over) the anchor structure icon or adjacent to the anchor structure icon. Thus, in one example, the step of allowing the user to select or manipulate positioning can be free-form with no constraints placed on the positioning other than the size of the electronic working space allowed for within the desktop space or website. In another example, the step of allowing the user to select or manipulate positioning can be based on a template (e.g., selected also by the user or preconfigured by the computer program).

With these general examples set forth above, it is noted in the present disclosure that when describing the system or related methods, individual or separate descriptions are considered applicable to one another, whether or not explicitly discussed in the context of a particular example or embodiment. For example, in discussing a particular anchor structure in the context of the system, the method embodiments are also inherently included in such discussions, and vice versa.

In further detail, the anchor structure can be configured to have a peripheral edge that includes an inverted portion defining a heart region. The heart region can be substantially surrounded by the inverted portion, e.g., more than 60% surrounded, or alternatively, completely surrounded by the inverted portion, e.g., similar to a donut hole arrangement of any hole shape. In either configuration, the anchor structure can have a first side and a second side that are each large enough to receive identity icons, and the first side and the second side can be separated by the heart region. Thus, the heart region can be used to apply interest icons and/or identity icons, as desired by the user.

In further detail, if the systems and methods are used to represent an individual, a single identity icon may be appropriate for use. However, if the system is being used to represent a family or a social group, multiple identity icons can be used on a common anchor structure. If a family is being represented, male members and female members may be represented by different symbols, if desired. Likewise, multiple generations may also be represented graphically in a different manner from one generation to the next. For example, a male son, a male father, and/or a male grandfather may be represented by unique symbols, examples of which are shown in the FIGS. hereinafter. Likewise, a female daughter, a female mother, and/or a female grandmother may likewise be represented by unique symbols. In another embodiment, if the various people represented on or about the anchor structure are part of a social group or club, various offices or other positions may be represented accordingly. For example, a president of a club might be represented by the letter “P” on the body of the identity icon, or might be represented by a number of bars associated with that office.

Interest icons are also part of the systems and methods of the present disclosure. For example, any of a number of interests can be used and associated with identity icons, representing interests of the person for whom the identity icon is placed. Suitable categories can be any category that meets the needs of a family or social group, but commonly, such interest icons can relate to sports, hobbies, occupations, beliefs, likes, or the like. In one example, the plurality of interest icons can be placed adjacent to the anchor structure in a manner that radiates outwardly from the identity icon and a peripheral edge of the anchor structure. In further detail, additional special symbols can be used in association with interest icons as well. For example, a stripe might be used or placed in close proximity to an interest icon to illustrate that a person not only likes that specific interest, but that there is some additional connection to that interest. For example, if the interest is a sport, an extra stripe might be used to indicate that they play that sport competitively, or that they compete or play at a certain level, e.g., beginning, intermediate, advanced, professional, etc. Additionally, icons or extra symbols stating relationship status, whether married, single, seeking relationship, etc., can also be included.

In one specific example, multiple anchor structures can be placed on a common substrate together, and identity icons and/or interest icons can be used to link multiple anchor structures together. For example, an engaged couple might place two anchor structures near one another on a wall or a car window with interest icons linking the two anchor structures together.

Suitable substrate that can be used to apply the graphics of the present disclosure together include walls, glass, magnetic boards, plastic surfaces, metal sheets, wood surfaces, hard surfaces on automobiles, or the like. Likewise, the substrate can be either flat or have a structural curve or other shape, as may be appropriate for a given application.

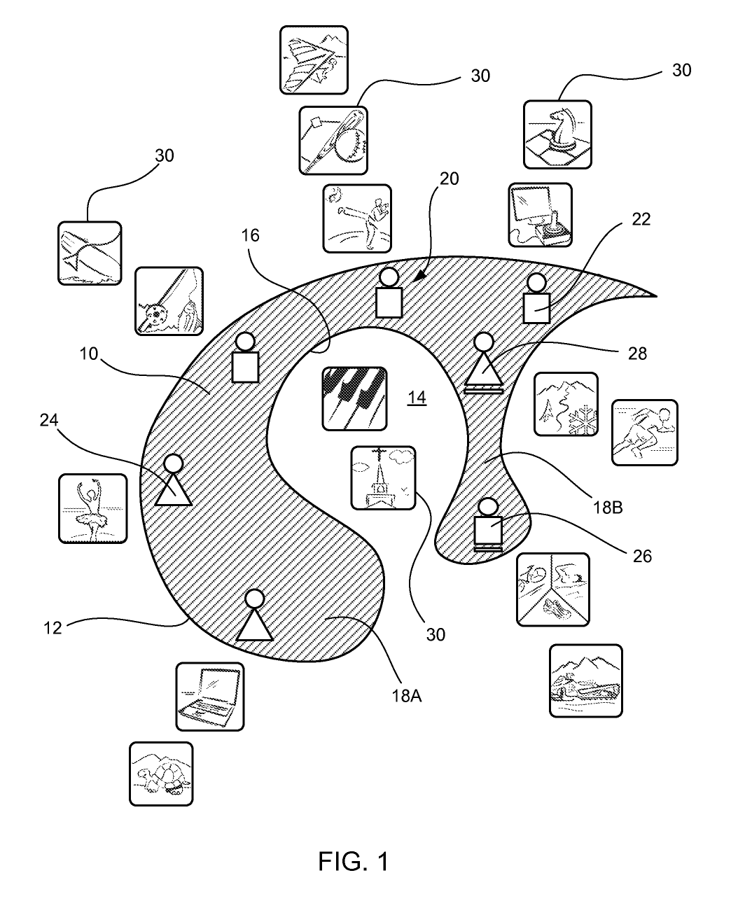

Turning now to the FIGS., various example embodiments are provided regarding how the anchor structure, identity icons, and interest icons might be displayed together. In FIG. 1, an anchor structure 10 is shown comprising a peripheral edge 12 which includes, in this embodiment, an inverted portion 16 defining a heart region 14. The heart region is not part of the anchor structure, but is defined within the inverted portion of the anchor structure. In fact, in this example, the inverted portion of the peripheral edge substantially surrounds the heart region, but does not completely surround the heart region. In other example, the heart region might be completely surrounded (not shown). Also, in this example, the anchor structure includes a first side 18A and a second side 18B separated primarily by the heart region.

FIG. 1 is organized using a family as an example. It is noted, however, that though this FIG. and the other FIGS. specifically exemplify families and individuals, examples of social clubs or other groups can be substituted for the family relationships exemplified herein. Family relationships are merely provided for convenience, but should not be considered as limiting to the present disclosure. With this in mind, identity icons 20 are provided of several varieties. Male son icons 22 and female daughter icons 24 are placed on the anchor structure 10. Likewise a male father icon 26 and a female mother icon 28 are shown, and in this example, include a bar across the bottom indicating an older generation. Two bars might be used to show a grandmother or a grandfather, and so forth. Other graphical methods might likewise be used to show these generational differences.

Interest icons 30 that are closely associated with each family member are also shown. The interest icons in this example radiate outwardly from the identity icons (just outside of the peripheral edge 12), but are not positioned on the anchor structure 10. This is not required, but is one example of how a user might arrange the interest icons relative to identity icons. In this example, one of the female daughters is shown to have an interest in dance, whereas one of the male sons appears to have an interest in computer games and chess. The father icon is shown to be associated with triathlons and snowmobiling and the mother icon is shown to be associated with skiing and running. As a further note, interest icons related to church and piano are positioned in the heart 14 of the anchor structure, indicating perhaps that music and God may be important to the entire family. This FIG. merely provides one example of how a family might represent its members and interests, and many other arrangements can also be personalized as per the desire of the user. As is shown clearly in this FIG., the interest icons are positioned in a close enough proximity to their respective identity icons that a clear graphical relationship between the identity icons and the interest icons is apparent, e.g., by close proximity, radial icon arrangement, enlarged spatial distance to unrelated icons, etc.

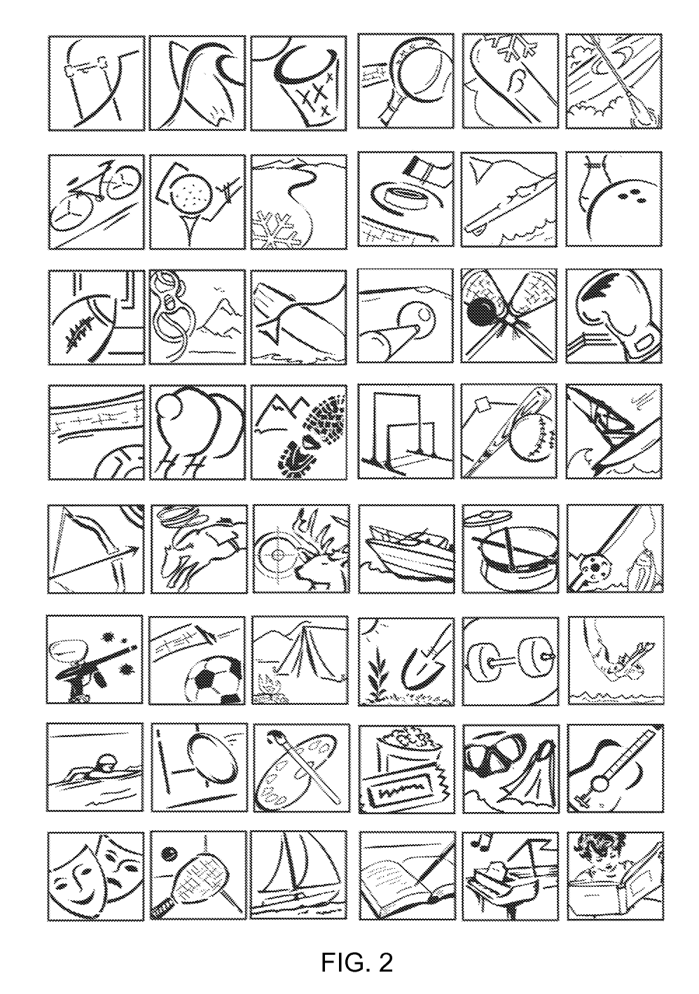

FIG. 2 is provided to show a sample sheet of many possible interest icons that can be used in accordance with the systems and methods of the present disclosure. Literally thousands of interest icons could be generated for the purpose of displaying interests of various people. These interest icons can be prepared to be any of a number of combinations of colors or black and white. The background can likewise be white, any color, or clear.

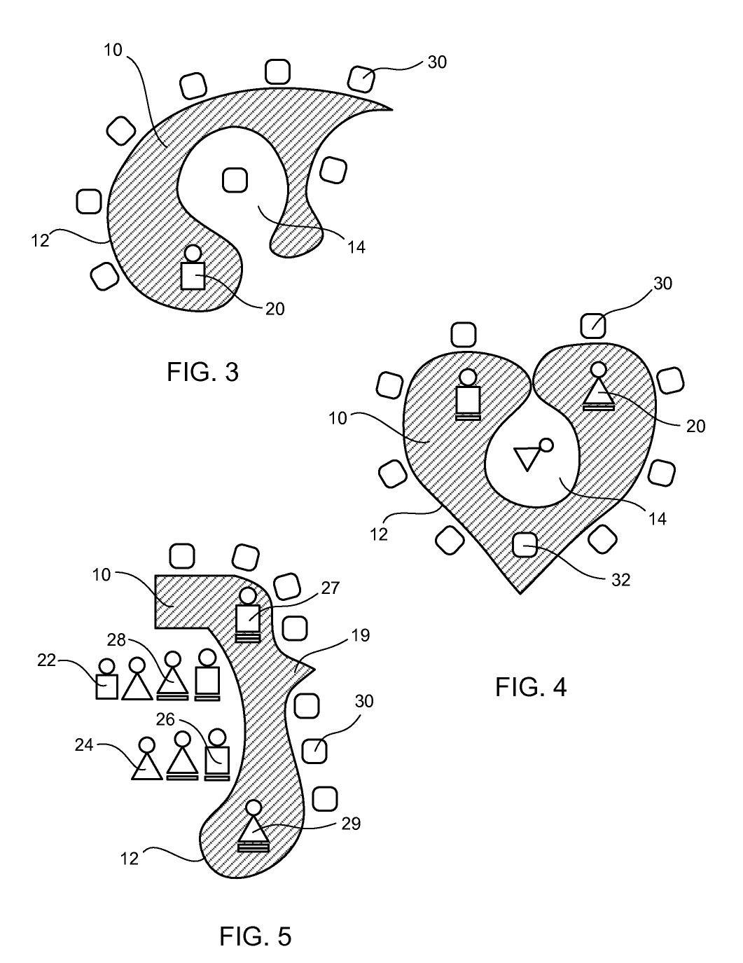

FIG. 3 sets forth another example of how the systems and methods of the present disclosure could be organized differently. In this FIG., an individual may organize an entire system for him/herself. In this example, the anchor structure 10 is the same as that described in FIG. 1. However, in this example, the identity icon 20 represents a single male (no family members or social group members are included, i.e. this graphical arrangement is personal to a single person). The interests (hobbies, sports, beliefs, occupation, likes, etc.) are arranged about the peripheral edge 12 in the form of interest icons 30. Because there are no other identity icons present on this anchor structure, the interest icons are clearly associated with the single identity icon. Also noted is a single interest icon positioned on the heart region 14 of the anchor structure, which may indicate a special or important interest.

FIG. 4 is an alternative arrangement where the anchor structure 10 is different in shape, but is still much larger than the identity icons 20 and the interest icons 30. As can be seen in this arrangement, a mother and a father are shown to have a female child positioned in the heart portion 14 of the anchor structure, indicating that the child is important and associated with both of them. By putting the female daughter icon in the heart region, the couple might likewise choose to place an interest in common on the anchor structure itself. Thus, interest icons related specifically to the female mother may be shown along the right peripheral edge of the anchor structure, and the interest icons of the male father might be placed along the left peripheral edge of the anchor icon, making it clear what interest icons are related to what identity icons. Common interest icons might be placed as shown at 32 on the anchor structure and between the two identity icons.

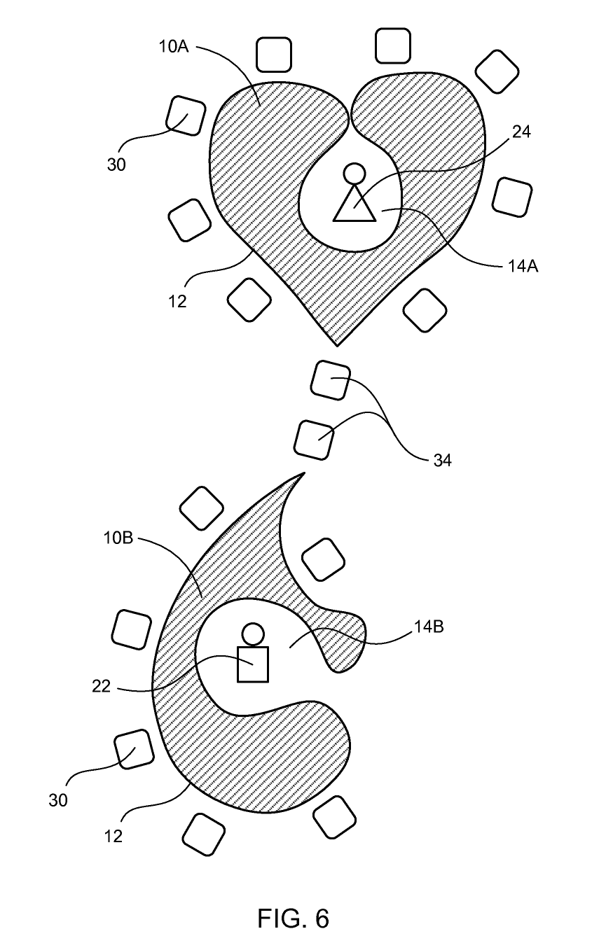

FIG. 5, on the other hand, shows three generations of family members with a grandfather 27, a grandmother 29, second generation fathers 26, second generation mothers 28, third generation sons 22, and third generation daughters 24. In this particular example, the anchor structure 10 does not include a heart region, but rather, the anchor structure includes two opposing sides where identity icons and interest icons can be placed, respectively. In this example, second generation and third generation identity icons are placed on the left side of the peripheral edge 12. Furthermore, interest icons 30 for the male grandfather 27 in this example are positioned along the peripheral edge on a right top portion of the anchor structure, and for the female grandmother 29, along the peripheral edge on the lower right portion. A protruding pointed structure is present on the on the anchor structure 19 to demarcate which interest icons belong two which identity icon.

FIG. 6 provides an example of two graphical organization systems that are both individualized and also linked together. In this example, a female identity icon 24 is placed in a heart region 14A of an anchor structure 10A. Likewise, a male identity icon 22 is placed in an alternative heart region 14B of an alternative anchor structure 10B. Interest icons 30 are positioned about the respective peripheral edge 12 of the respect anchor structures indicating personal interests. Again, in both cases, it is clear which interest icons are associated with which identity icons because each anchor structure is personal to only a single identity icon. However, also present are linking interest icons 34 that placed between the respective anchor structures indicating shared interests.

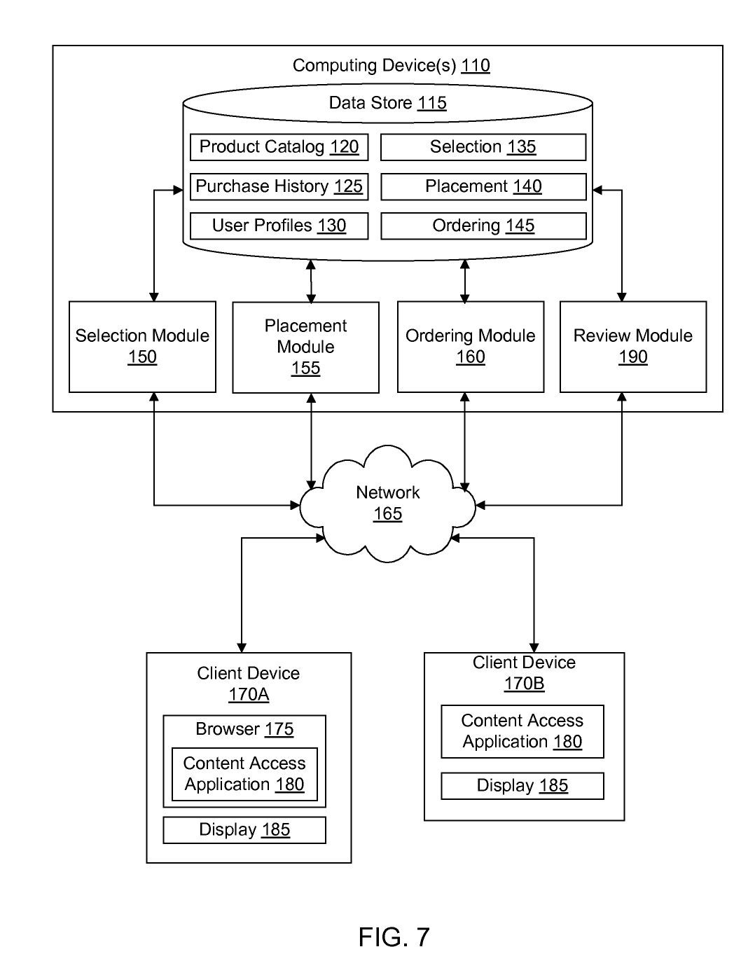

In the following discussion, a general description of an example system and the system's components are provided, followed by a discussion of the operation of the system for providing the technology. As illustrated in FIG. 7, a system for graphically organizing people and interests is shown. It is noted that not all modules or other system features are required for each method of the present disclosure. These features, information, and modules are provided merely for convenience to show an example system that can work over multiple methods described herein. For example, a review module is shown, but review is not necessarily required for the methods described herein.

More specifically, FIG. 7 shows a networked environment according to various examples of the present technology. The networked environment may include one or more computing devices 110 in data communication with a first and/or second screen device or client device(s) 170A, 1708 by way of a network 165. The network may include the Internet, intranets, extranets, wide area networks (WANs), local area networks (LANs), wired networks, wireless networks, or other suitable networks, etc., or any combination of two or more such networks.

The computing device 110 may comprise, for example, a server computer or any other system providing computing capability. Alternatively, a plurality of computing devices may be employed that are arranged, for example, in one or more server banks, computer banks, or other computing arrangements. For example, a plurality of computing devices together may comprise a cloud computing resource, virtualization server, a grid computing resource, and/or any other distributed computing arrangement. Such computing devices may be located in a single installation or may be distributed among many different geographical locations. For purposes of convenience, the computing device is referred to herein in the singular. Even though the computing device is referred to in the singular, it is understood that a plurality of computing devices may be employed in the various arrangements as described above.

The first screen device or client 170A and the second screen device or client 1708 is representative of a plurality of client devices that may be coupled to the network 165. The first and second screen clients may comprise, for example, a processor-based system such as a computer system. Such a computer system may be embodied in the form of a desktop computer, a laptop computer, personal digital assistants, cellular telephones, smart phones, set-top boxes, network-enabled televisions, music players, tablet computer systems, game consoles, electronic book readers, or other devices with like capability. The first screen client, (e.g., desktop computer, laptop computer, or television) may have lesser mobility and be larger in size as compared with the second screen client (e.g., a mobile phone or a tablet computer).

The first screen client device 170A and/or the second screen client device 170B may be configured to execute various applications such as a browser 175 and/or other content access application(s) 180 and appropriate display 185.

Either can be on a standard computers or networks, smart phones or tablet computers, though these lists are not intended to be limiting, for example. The applications may correspond to code that is executed in the browser. The first screen client and/or the second screen client may correspond to standalone applications, such as mobile applications. In addition, the first screen client and/or the second screen client may be configured to execute applications that include, but are not limited to, video playback applications, standalone applications, email applications, instant message applications, and/or other applications. The applications may play video content on the first screen client. In examples where a browser is used, such as with the first screen client, the browser may be executed, for example, to access and render network pages, such as network pages (e.g. web pages), or other network content served up by the computing device 110 and/or other servers. The display for the first screen client may comprise, for example, one or more devices such as cathode ray tubes (CRTs), liquid crystal display (LCD) screens, gas plasma-based flat panel displays, LCD projectors, or other types of display devices, etc.

Various applications and/or other functionality may be executed in the computing device 110 according to various embodiments. Also, various data may be stored in a data store 115 that is accessible to the computing device. The term “data store” may refer to any device or combination of devices capable of storing, accessing, organizing, and/or retrieving data, which may include any combination and number of data servers, relational databases, object oriented databases, simple web storage systems, cloud storage systems, data storage devices, data warehouses, flat files, and data storage configuration in any centralized, distributed, or clustered environment. The storage system components of the data store may include storage systems such as a SAN (Storage Area Network), cloud storage network, volatile or non-volatile RAM, optical media, or hard-drive type media. The data stored in the data store, for example, may be associated with the operation of the various applications and/or functional entities described below.

The data stored in the data store 115 may include a product catalog 120, purchase history information 125, user profiles 130, selection information 135, placement information 140, ordering information 145, and/or the like. A selection module 150 can be used by a user to make selections regarding anchor structures, identity icons, interest icons, etc. Once selections are made, or simultaneously with the selection process, the user can use the placement module 155 to position the icons graphically on a computer display to visualize spatial relationships between structures and icons, colors, overall look and feel of the personalized designed to be created by the user, and/or the like. It is noted that use of the placement module would be optional, and not required for ordering product. That being said, an ordering module 160 could be linked to the selection module for ordering product, or alternatively, the ordering module could optionally be linked to the placement module such that when the user has finished placing the structures and icons, the ordering module could be used to order the desired media (e.g., stickers, magnets, or other medium of graphical structures and icons) needed to build the modular image that is displayed on the computer display. As a further note, an optional review module 190 may be present, allowing users to review the experience on the site or the review the product that they have received.

Certain processing modules may be discussed in connection with this technology and FIG. 7. In one example configuration, a module may be considered a service with one or more processes executing on a server or other computer hardware. Such services may be centrally hosted functionality or a service application that may receive requests and provide output to other services or consumer devices. For example, modules providing services may be considered on-demand computing that is hosted in a server, cloud, grid, or cluster computing system. An application program interface (API) may be provided for each module to enable a second module to send requests to and receive output from the first module. Such APIs may also allow third parties to interface with the module and make requests and receive output from the modules. Third parties may either access the modules using authentication credentials that provide on-going access to the module or the third party access may be based on a per transaction access where the third party pays for specific transactions that are provided and consumed.

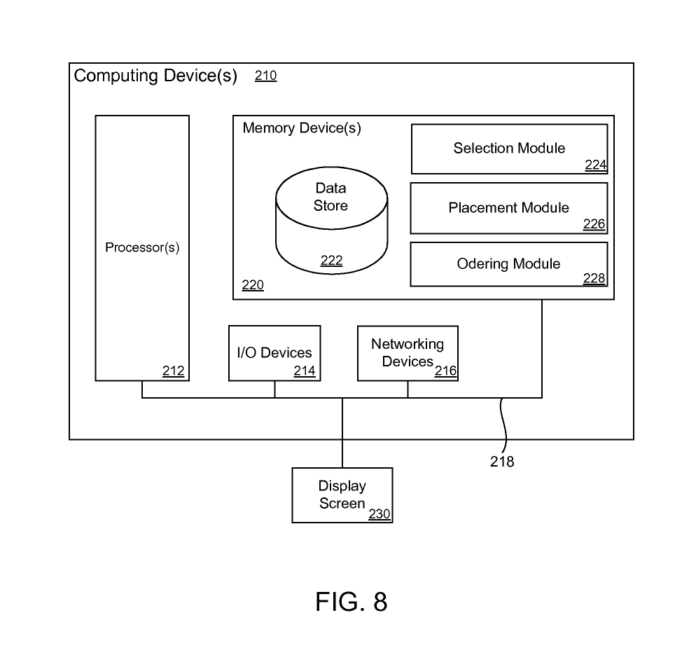

FIG. 8 illustrates a computing device 210 on which modules of this technology may execute. More specifically, a computing device is illustrated on which a high level example of the technology may be executed. The computing device may include one or more processors 212 that are in communication with memory devices 220. The computing device may include a local communication interface 218 for the components in the computing device. For example, the local communication interface may be a local data bus and/or any related address or control busses as may be desired.

The memory device(s) 220 may contain modules that are executable by the processor(s) 212 and data for the modules. Located in the memory device are modules executable by the processor. For example, a selection module 224, a placement module 226, an ordering module 228, and/or other modules may be located in the memory device. The modules may execute the functions described earlier. A data store 222 may also be located in the memory device for storing data related to the modules and other applications along with an operating system that is executable by the processor(s).

Other applications may also be stored in the memory device 220 and may be executable by the processor(s) 212. Components or modules discussed in this description may be implemented in the form of software using high programming level languages that are compiled, interpreted or executed using a hybrid of the methods.

The computing device may also have access to I/O (input/output) devices 214 that are usable by the computing devices. An example of an I/O device is a display screen 230 that is available to display output from the computing devices. Other known I/O device may be used with the computing device as desired. Networking devices 216 and similar communication devices may be included in the computing device. The networking devices may be wired or wireless networking devices that connect to the internet, a LAN, WAN, or other computing network.

The components or modules that are shown as being stored in the memory device 220 may be executed by the processor 212. The term “executable” may mean a program file that is in a form that may be executed by a processor. For example, a program in a higher level language may be compiled into machine code in a format that may be loaded into a random access portion of the memory device and executed by the processor, or source code may be loaded by another executable program and interpreted to generate instructions in a random access portion of the memory to be executed by a processor. The executable program may be stored in any portion or component of the memory device. For example, the memory device may be random access memory (RAM), read only memory (ROM), flash memory, a solid state drive, memory card, a hard drive, optical disk, floppy disk, magnetic tape, or any other memory components.

The processor(s) 212 may represent multiple processors and the memory 220 may represent multiple memory units that operate in parallel to the processing circuits. This may provide parallel processing channels for the processes and data in the system. The local interface 218 may be used as a network to facilitate communication between any of the multiple processors and multiple memories. The local interface may use additional systems designed for coordinating communication such as load balancing, bulk data transfer, and similar systems.

While the flowcharts presented for this technology may imply a specific order of execution, the order of execution may differ from what is illustrated. For example, the order of two more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

What is claimed is:

1. A modular system of graphically depicting people and interests, comprising:
an anchor structure having a dimensional area;
an identity icon adapted to be positioned on or adjacent to the anchor structure, the identity icon having an area no larger than 25% of the dimensional area of the anchor structure; and
a plurality of interest icons adapted to be positioned on or adjacent to the anchor structure, wherein a single interest icon has an area no larger than 25% of the dimensional area of the anchor structure.

2. The system of claim 1, wherein anchor structure has a peripheral edge that includes an inverted portion defining a heart region.

3. The system of claim 1, comprising a plurality an identity icons adapted to be positioned on or adjacent to the anchor structure.

4. The system of claim 4, wherein the plurality of identity icons represent multiple family members or multiple members of a common social relationship or social circle.

5. The system of claim 4, wherein the plurality of identity icons includes both symbols for male members differentiated from symbols for female members.

6. The system of claim 1, wherein the interest icons are categorized into multiple categories including at least one of sports, hobbies, occupation, beliefs, and likes.

7. The system of claim 1, adapted so that multiple anchor structures are linkable together by either an identity icon or an interest icon.

8. The system of claim 1, wherein the identity icon has an area no larger than 10% of the dimensional area of the anchor structure, or the single interest icon has an area no larger than 10% of the dimensional area of the anchor structure.

9. The system of claim 1, wherein the single interest icon has a graphical relationship to the identity icon.

10. A method of graphically depicting people and interests, comprising:
obtaining an anchor structure, an identity icon, and a plurality of interest icons;
affixing the anchor structure to a substrate;
affixing the identity icon to the anchor structure or adjacent to the anchor structure; and
affixing at least one interest icon of the plurality of interest icons on the anchor structure or adjacent to the anchor structure at a location having a graphical relationship to the identity icon.

11. The method of claim 10, wherein the identity icon is placed on the anchor structure.

12. The method of claim 10, wherein one or more of the interest icons are placed adjacent to or on the anchor structure in a manner that is related to the identity icon.

13. The method of claim 10, wherein the anchor structure includes a peripheral edge having an inverted portion defining a heart region, and wherein the method further comprises placing an interest icon or an identity icon within the heart region.

14. The method of claim 10, comprising affixing a plurality of identity icons on or adjacent to the anchor structure, wherein the plurality of identity icons represents family members or members of a common social relationship or social circle.

15. The method of claim 10, further comprising affixing multiple anchor structures to the substrate and linking the multiple anchor structures together by an identity icon or an interest icon.

16. A method of digitally representing people and interests, comprising:
electronically displaying an anchor structure icon, identity icons, and interest icons; and
allowing a user to select or manipulate positioning of the anchor structure icon, one or more of the identity icons, or one or more of the interest icons on a computer display to generate an organized arrangement of the anchor structure icon, one or more of the identity icons, and one or more of the interest icons, thereby providing a graphical representation of a personal relationship or interest information; and
providing an option for ordering physical media product represented digitally by the organized arrangement,
wherein one or more of the steps is carried out over a computer network.

17. The method of claim 16, further comprising the step of electronically displaying multiple anchor structure icons and allowing the user to select one or more of the multiple anchor structure icons.

18. The method of claim 16, wherein the identity icons or the interest icons are graphically positionable either on the anchor structure icon, adjacent to the anchor structure icon, or both

19. The method of claim 16, wherein the step of allowing the user to select or manipulate positioning is free-form with no constraints placed on the positioning other than the size of the electronic working space.

20. The method of claim 16, wherein the step of allowing the user to select or manipulate positioning is based on a template.
